(19) United States
(12) Patent Application Publication
(10) Pub. No.: US 2018/0035207 A1
(43) Pub. Date: Feb. 1, 2018

(54) MONITORING AND HEARING AID HEADPHONE INTERCOM SYSTEM

(71) Applicant: CHUNG-YEH HSU, NEW TAIPEI CITY (TW)

(72) Inventor: CHUNG-YEH HSU, NEW TAIPEI CITY (TW)

(21) Appl. No.: 15/657,524

(22) Filed: Jul. 24, 2017

Related U.S. Application Data
(60) Provisional application No. 62/367,142, filed on Jul. 27, 2016.

(51) Int. Cl. H04R 3/12; H04W 4/00; H04W 76/02; H04R 1/10

(52) U.S. Cl. CPC H04R 3/12; H04R 1/1041; H04R 1/1025; H04W 4/008; H04W 76/023; H04W 76/025; H04R 2420/07; H04R 2201/107; H04R 2430/01

(57) ABSTRACT

A monitoring and hearing aid headphone intercom system is revealed. The system includes one primary headphone, at least one secondary headphone and a terminal device. The primary headphone is disposed with a first Bluetooth module, a first ISM (Industrial Scientific Medical) module, a first microphone set, and a first wired connection module. The secondary headphone is arranged with a second Bluetooth module, a second ISM (Industrial Scientific Medical) module, and a second microphone set. The secondary headphone is connected to the primary headphone by the second ISM module while the terminal device is connected to either the primary headphone or the secondary headphone by a third Bluetooth module or an input cable. Thereby audio signals the primary headphone received are shared with the secondary headphone. Users of the primary headphone and the secondary headphone can interact with each other.

### BACKGROUND OF THE INVENTION

### Field of the Invention

The present invention relates to a headphone intercom system, especially to a monitoring and hearing aid headphone intercom system that supports both one-to-one interaction and one-to-many interaction for allowing the primary headphone to share the audio signals received and have interaction with the secondary headphone. Both the primary and the secondary headphones can be used to monitor sounds from outside and pick up phone calls from mobile phones. The present system provides users multiple functions and makes the headphone system more convenient in use.

### Description of Related Art

The headphone is a kind of speaker set over a user's ears while in use. The speaker converts electrical signals to audible sounds that allow the users to listen. In early days, the headphones are used in telephone network and wireless communications. With development and prevalence of portable electronics, headphones are gradually applied to mobile phones, computers, digital audio players, stereos, TV game consoles, etc. The electronics and the headphone are connected by an audio cable such as TRS cable. Yet the audio cable is easily damaged owing to bending or pulling forces occurred in use or storage. The poor connection resulted from damages leads to poor audio quality and the sounds the user heard are muddy and unclear. This causes certain problems.

In order to solve the problems of the cable, the Bluetooth technology has been applied to the headphones and Bluetooth headphones have been developed. There is no need to use the cable owing to wireless feature of the Bluetooth. Both the electronic device and the headphone should be equipped with the Bluetooth module while in use. The electronic device and the headphone are paired by the Bluetooth technology. After being paired successively, signals are transmitted and exchanged between the two devices. The electrical signals are transmitted from the electronic device to the Bluetooth headphone while the Bluetooth headphone converts the electrical signals to audible sounds for users. Moreover, cordless Bluetooth headsets are available and often used with mobile phones, allowing the user to take calls. Thus the user can answer the phone call by one-click and the hands-free feature reduces visual distraction for drivers in the car.

There are many Bluetooth headphones available on the market now. Refer to Taiwanese Pat. No. TW 1533719 B, “wireless headphone and method for control of audio signals played therefrom” is revealed. A Bluetooth headphone is used for answering phone calls or playing music. The Bluetooth headphone doesn't include the cable that provides power so that the Bluetooth headphone needs battery charging or replacement. In this prior art, the Bluetooth headphone stops working according to two criteria in order to save power. The criteria are the detection of the light source in the environment and checking whether there is blocking signal from the user's ear. Refer to Taiwanese Pat. No. TW 1543637 B, a headphone wireless expansion device with multiple switchable targets and a voice control method thereof are revealed. The headphone wireless expansion device is paired with a plurality of information devices for data storage. The pairing is performed by the Bluetooth module of the headphone wireless expansion device. Thus the pairing process is not performed again when the headphone and the information device is connected again. Thus the headphone can be switched between at least two information devices for output audio signals in the information device by the headphone.

However, the Bluetooth headphone and the electronic devices are connected one-to-one even the electronic device connected to the Bluetooth headphone can be switched freely. Only the user his own Bluetooth headphone can output audio signals. The headphone system available on the market now only includes a single headphone, without interaction among multiple headphones.

Thus there is room for improvement and a need to provide a novel headphone system that solves the problems mentioned above and has more applications, without being limited to only one wireless headphone in use.

### SUMMARY OF THE INVENTION

Therefore it is a primary object of the present invention to provide a monitoring and hearing aid headphone intercom system that supports both one-to-one interaction and one-to-many interaction for allowing the primary headphone and the secondary headphone to share audio signals received by the primary headphone and have interaction therebetween. Not only one secondary headphone but also a plurality of secondary headphones can receive and share the audio signals. The present system can be used in teaching, touring and meetings. Moreover, either the primary headphone or the secondary headphone can be used to monitor sounds from outside and pick up phone calls from mobile phone. The wireless headphones have more applications.

In order to achieve the above object, a monitoring and hearing aid headphone intercom system according to the present invention includes a primary headphone, at least one secondary headphone, and a terminal device. The primary headphone is disposed with a first Bluetooth module, a first ISM (Industrial Scientific Medical) module, a first microphone set, and a first wired connection module. The secondary headphone is arranged with a second Bluetooth module, a second ISM module, and a second microphone set. The secondary headphone is connected to the primary headphone by the second ISM module while the terminal device is connected to either primary headphone or the secondary headphone by a third Bluetooth module or an input cable.

Both the primary headphone and the secondary headphone further include a power supply module that uses a lithium battery or a solar cell as a power source.

The lithium battery is charged via a USB port.

The frequency band of both the first ISM module and the second ISM module is 2.4 GHz band.

Both the first microphone set and the second microphone set include a phone microphone, a monitor microphone, and a walkie talkie wireless microphone respectively.

The phone microphone, the monitor microphone, and the walkie talkie wireless microphone of the present invention can be selected from the following microphones: a dynamic microphone, a condenser microphone, an electret condenser microphone and a microelectromechanical systems (MEMS) microphone.

The terminal device can be a smartphone, a tablet computer, a laptop computer, a desktop computer or an audio player.

Both the primary headphone and the secondary headphone are arranged with a volume button for adjusting the volume output.

Both the primary headphone and the secondary headphone can be either a circumaural headphone or an ear-fitting headphone.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1 is a perspective view of a primary headphone of an embodiment according to the present invention;

FIG. 2 is another perspective view of a primary headphone of an embodiment according to the present invention;

FIG. 3 is a perspective view of a secondary headphone of an embodiment according to the present invention;

FIG. 4 is another perspective view of a secondary headphone of an embodiment according to the present invention;

FIG. 5 is a system block diagram of an embodiment according to the present invention;

FIG. 6 is a schematic drawing showing an embodiment in use according to the present invention;

FIG. 7 is another schematic drawing showing an embodiment in use according to the present invention.

### DETAILED DESCRIPTION OF THE PREFERRED EMBODIMENT

In order to learn technical content, purposes and functions of the present invention, please refer to the following embodiments, related figures and detailed descriptions.

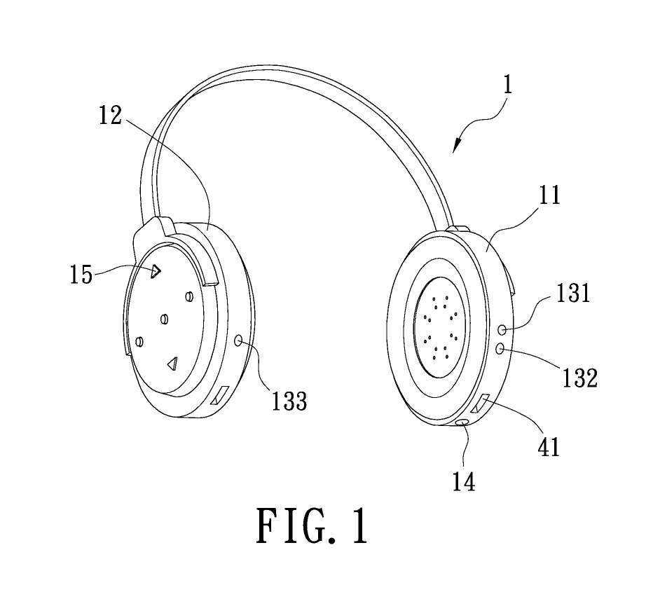

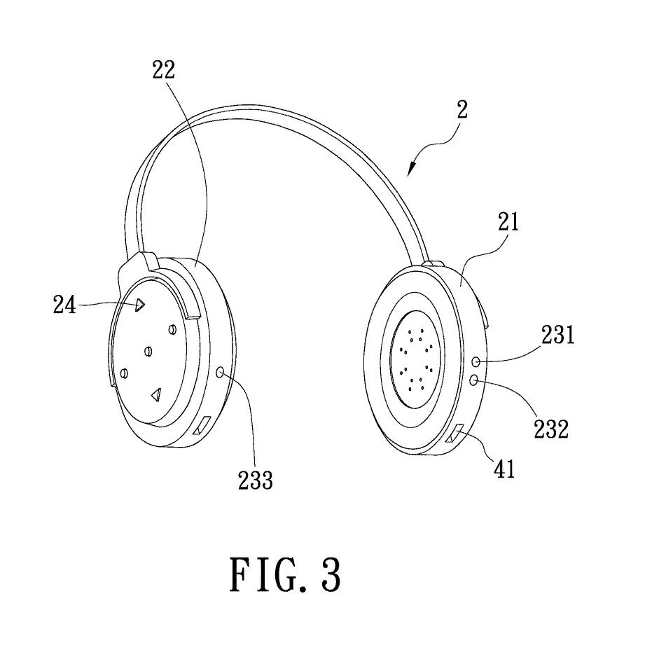

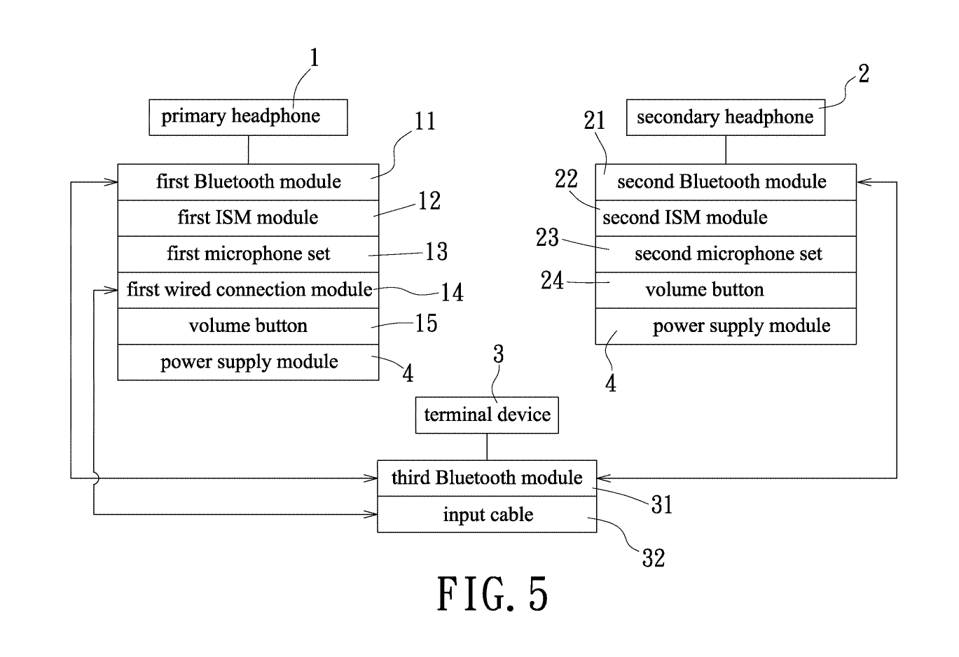

Refer to FIG. 1, FIG. 3 and FIG. 5, a monitoring and hearing aid headphone intercom system according to the present invention includes one primary headphone 1, at least one secondary headphone 2, and a terminal device 3. The primary headphone 1 and the secondary headphone 2 can be either a circumaural headphone or an ear-fitting headphone. The terminal device 3 can be a smartphone, a tablet computer, a laptop computer, a desktop computer or an audio player.

The primary headphone 1 includes a first Bluetooth module 11, a first ISM (Industrial Scientific Medical) module 12, a first microphone set 13, a first wired connection module 14, and a volume button 15 for adjusting the volume output therefrom. As to the secondary headphone 2, it is arranged with a second Bluetooth module 21, a second ISM (Industrial Scientific Medical) module 22, a second microphone set 23, and a volume button 24 for adjusting the volume output therefrom. The secondary headphone 2 is connected to the primary headphone 1 by the second ISM module 22 while the terminal device 3 is connected to the primary headphone 1 or the secondary headphone 2 by a third Bluetooth module 31 or an input cable 32. The primary headphone 1 and the secondary headphone 2 further include a power supply module 4 respectively that uses a lithium battery or a solar cell as a power source. The lithium battery can be charged via a USB port 41 on the primary headphone 1 and on the secondary headphone 2 respectively. The frequency band of both the first ISM module 12 and the second ISM module 22 is 2.4 GHz band.

The first microphone set 13 and the second microphone set 23 are composed of a phone microphone 131, 231, a monitor microphone 132, 232, and a walkie talkie wireless microphone 133, 233 respectively. Each of the above microphones can be selected from the following microphones: dynamic microphone, condenser microphone, electret condenser microphone and MEMS microphone.

Thereby the primary headphone 1 and the secondary headphone 2 are connected to each other by the first ISM module 12 and the second ISM module 22 while the terminal device 3 is connected to the primary headphone 1/or the secondary headphone 2 by the third Bluetooth module 31 or the input cable 32. Thus audio signals from the terminal device 3 can be transmitted to the primary headphone 1 and the secondary headphone 2. Once the primary headphone 1 receives the audio signals, the audio signals can be shared with at least one secondary headphone 2 so that the wireless headphone has more applications.

The applications of the present invention are further illustrated by the following embodiments, but not intended to limit the scope of the present invention.

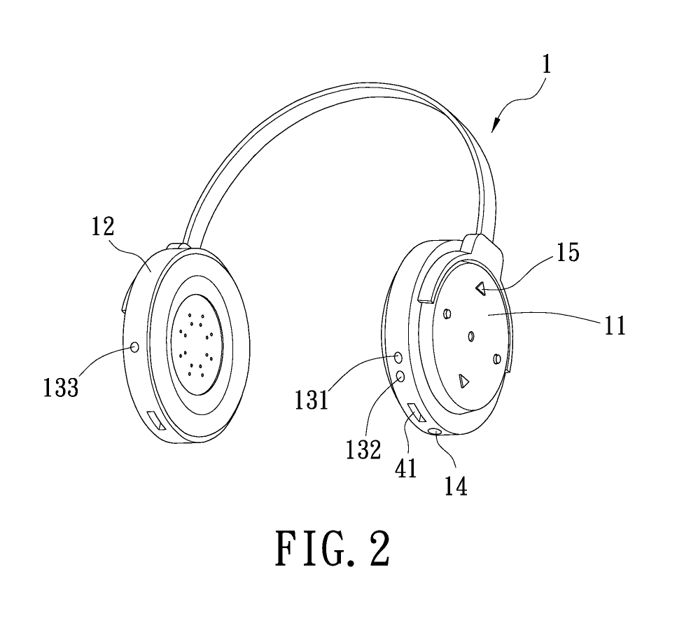

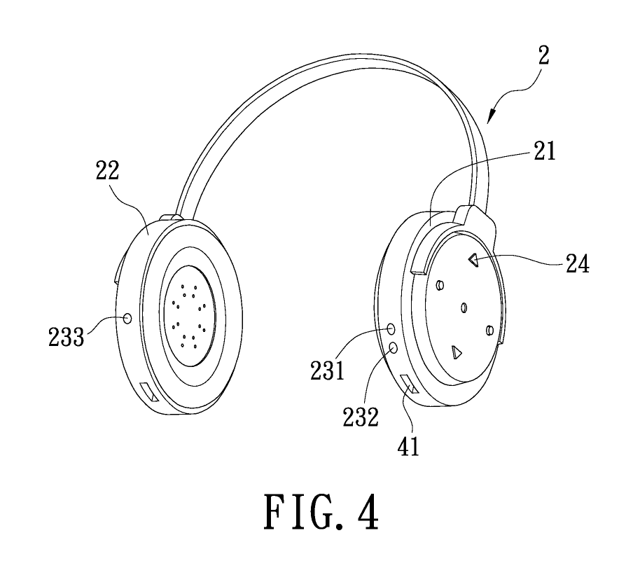

Refer from FIG. 1 to FIG. 5, the present invention includes one primary headphone 1, at least one secondary headphone 2, and a terminal device 3. In these embodiments, both the primary headphone 1 and the secondary headphone 2 are circumaural headphones. Each of the headphones 1, 2 has two loudspeakers. A foam pad sits around user's ear and encloses the loudspeaker in order to stop any outside noise from reaching user's ear. The combination of the loudspeaker with the foam pad is called an earcup which provides better comfort while the user wearing the primary headphone 1 or the secondary headphone 2. The two earcups are connected by a curved headband that ensures a fit around the user's head. The position of the earcup relative to the headband can be adjusted for a proper fit over the user's ear. The first Bluetooth module 11 and the first ISM module 12 of the primary headphone 1 are mounted in the earcup while the phone microphone 131, the monitor microphone 132, and the walkie talkie wireless microphone 133 of the first microphone set 13 are arranged at a surface around the earcup, close to the user's mouse. The first wired connection module 14 is set on a lower side of one of the earcups. The disposition of the secondary headphone 2 is the same as the primary headphone 1. The second Bluetooth module 21 and the second ISM module 22 of the secondary headphone 2 are mounted in the earcup while the phone microphone 231, the monitor microphone 232, and the walkie talkie wireless microphone 233 of the second microphone set 23 are arranged at a surface around the earcup, close to the user's mouse. A second wired connection module is set on a lower side of one of the earcups.

According to the microphone types, the present headphone system provides three-modes-phone answering mode, monitoring and hearing aid mode, and intercom mode. In the phone answering mode, first the first Bluetooth module 11 of the primary headphone 1/or the second Bluetooth module 21 of the secondary headphone 2 is first paired with the third Bluetooth module 31 of the terminal device 3. Thus users can use the primary headphone 1 or the secondary headphone 2 to answer the phone call when the terminal device 3 receives a phone call. Once the user wears the primary headphone 1, he/she can hear the caller through the earcups of the primary headphone 1 and answer the call directly by the phone microphone 131 of the first microphone set 13. If the user wears the secondary headphone 2, he/she can hear the caller through the earcups of the secondary headphone 2 and answer the call directly by the phone microphone 231 of the second microphone set 23.

In the monitoring and hearing aid mode, the primary headphone 1 and the secondary headphone 2 are used independently, without being paired or connected with other devices. The monitor microphone 132 of the first microphone set 13 and the monitor microphone 232 of the second microphone set 23 receives sounds outside the earcups when the user turns on the monitoring mode of the primary headphone 1 and the secondary headphone 2. Thus the user can still hear sounds from outside in the monitoring mode even the earcups are equipped with foam pads. Moreover, the user can control volume output from the earcup by the volume buttons 15, 24 respectively to amplify the sounds from outside for hearing-aid assistance. Thus the monitoring mode allows the user to wear the headphone when they need to hear the sounds from outside or talk face to face, without removing the headphone from their ears.

In the intercom mode, the primary headphone 1 and the secondary headphone 2 are connected for users wearing them to have conversation. In order to turn on the intercom mode, the user wearing the primary headphone 1 and the user wearing the secondary headphone 2 should press an activation key for the first ISM module 12 or the second ISM module 22 on their headphones until the indicator light is on. This means the primary headphone 1 and the secondary headphone 2 are paired successfully. In order to prevent too much noise interference on the speaker of the earcup, only one primary headphone 1 and one secondary headphone 2 are used to have conversation at a time. The primary headphone 1 receives audio signals by the walkie talkie wireless microphone 133 of the first microphone set 13 and the secondary headphone 2 receives audio signals by the walkie talkie wireless microphone 233 of the secondary microphone set 23 when the users are in a conversation. The users hear each other's voices through the respect earcups. If the users intend to disconnect the primary headphone 1 and the secondary headphone 2, briefly press the activation key for the first ISM module 12 to be out of the paired state. The ISM module of the primary headphone 1 and that of the secondary headphone 2 are operating in the 2.4 GHz free band that includes a plurality of preset channels. Each set of the headphone system has its own identification code. Thus there is no crosstalk even there is a plurality of sets of the present headphones system within the area.

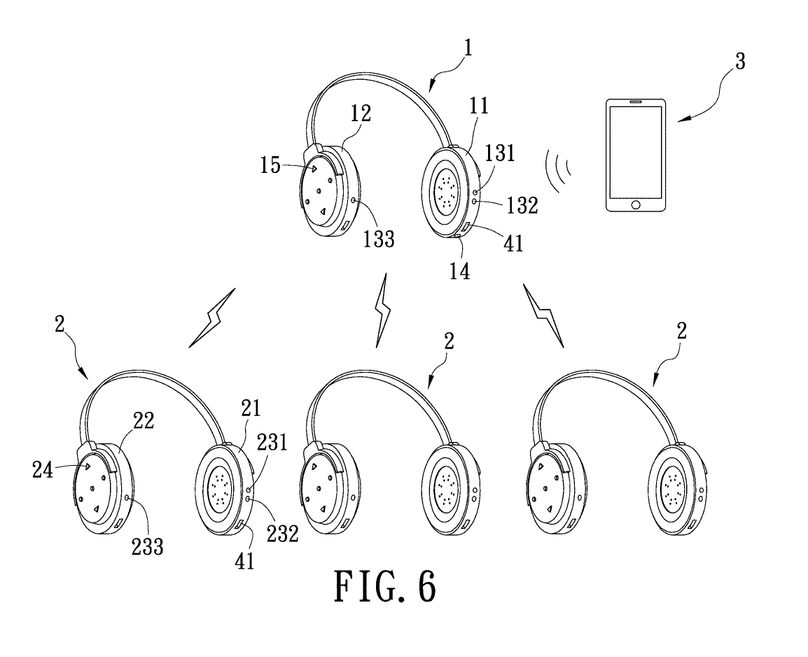

Besides the above three modes, the present system further includes audio sharing. As shown in FIG. 6, the primary headphone 1 and a plurality of secondary headphones 2 share audio signals. First the first Bluetooth module 11 of the primary headphone 1 is paired with the third Bluetooth module 31 of the terminal device 3. The user can learn the devices able to be paired through the terminal device 3. After the primary headphone 1 being selected and connected successively, the user can player music or other audio files by the terminal device 3. Now the audio signals are played through the earcups of the primary headphone 1 to be heard by the user wearing the primary headphone 1. Next the audio signals are transmitted to each secondary headphone 2 of the headphone system by the first ISM module 12 of the primary headphone 1. The ISM module 22 of the second headphone 2 receives the audio signals from the primary headphone 1 so that the users who wear the second headphone 2 can hear the same sounds as the user wearing the primary headphone 1. For example, the teacher can wear the primary headphone 1 and the students can wear the secondary headphones 2 respectively when the teacher is teaching the students in a teaching environment. Then the primary headphone 1 and the terminal device 3 are paired together by the teacher for communication using Bluetooth and an English conversation is played on the terminal device 3. The English conversation is transmitted to the respect secondary headphone 2 of each student in a wireless way. The teacher can also state and explain the content of the English conversation through the walkie talkie wireless microphone 133 of the first microphone set 13. Now the primary headphone 1 and the secondary headphone 2 are not paired on-to-one. Thus the earphone 1 provides a one-to-many connection.

Once the terminal device 3 is not disposed with the third Bluetooth module 31, the terminal device 3 is electrically connected to the first wired connection module 14 of the primary headphone 1 by the input cable 32. The input cable 32 is formed by wires with TRS connectors available on the market. By the first wired connection module 14, the primary headphone 1 receives the audio files from the terminal device 3 in a wired way and then the audio signals of the audio files are transmitted to the secondary headphone 2 in a wireless way. The design allows the present headphone system having more applications, able to be used together with the terminal device 3 having different specifications.

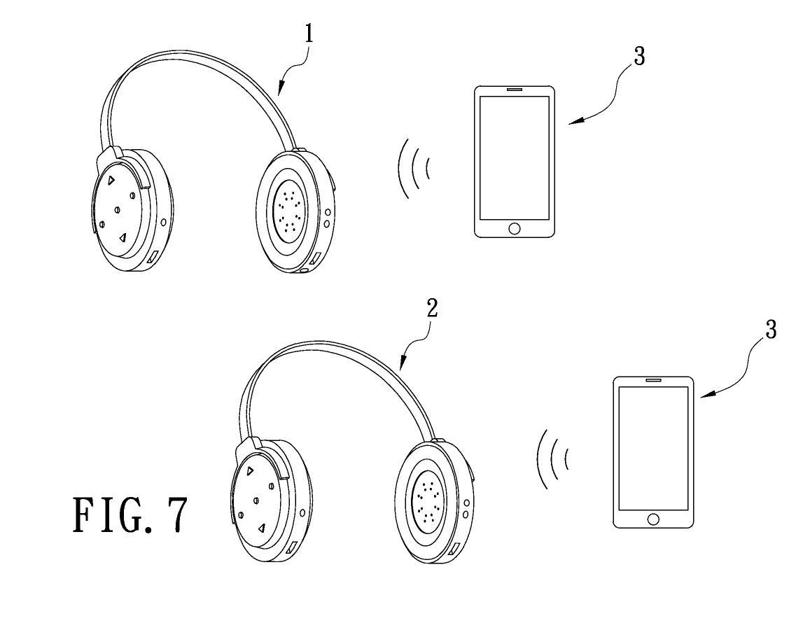

Refer to FIG. 7, the secondary headphone 2 is also able to directly connect to the terminal device 3 by the second Bluetooth module 21 and the third Bluetooth module 31, in the same way as the primary headphone 1 paired with the terminal device 3. The user can learn the devices able to be paired by the terminal device 3. After the secondary headphone 2 being selected and connected successively, the audio files played on the terminal device 3 are output from the earcups of the secondary headphone 2. The user wearing the secondary headphone 2 can get the audio signals from the terminal device 3 without being connected to the primary headphone 1.

Compared with the system available now, the present invention has the following advantages:

1. The monitoring and hearing aid headphone intercom system of the present invention includes the primary headphone, at least one secondary headphone, and the terminal device. The primary headphone and the terminal device are connected by Bluetooth and then the primary headphone is connected to at least one secondary headphone by ISM wireless communication. Thus the audio signals from the terminal device are transmitted to each secondary headphone through the primary headphone. The on-to-many design expands the application range of the wireless headphones. Thus the wireless headphone is more convenient in use and able to have more functions.

2. Both the primary headphone and the secondary headphone of the present system include the phone microphone, the monitor microphone and the walkie talkie wireless microphone. Thus both headphones have the phone answering mode, the monitoring and hearing aid mode, and the intercom mode. The user can not only answer the phone call from the terminal device connected at any time but also hear sounds from outside by the monitor microphone, and even get hearing aid function without taking off the headphone. The users can talk directly when the primary headphone and the secondary headphone are connected by the ISM modules. The design makes the present headphone system easy and convenient to use.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalent.

What is claimed is:

1. A monitoring and hearing aid headphone intercom system comprising:
a primary headphone that is disposed with a first Bluetooth module, a first ISM (Industrial Scientific Medical) module, a first microphone set, and a first wired connection module;
at least one secondary headphone that is arranged with a second Bluetooth module, a second ISM module, and a second microphone set; wherein the secondary headphone is connected to the primary headphone by the second ISM module; and
a terminal device that is connected to either the primary headphone or the secondary headphone by a third Bluetooth module or an input cable.

2. The system as claimed in claim 1, wherein the primary headphone and the secondary headphone further include a power supply module respectively; the power supply module uses a lithium battery or a solar cell as a power source.

3. The system as claimed in claim 2, wherein the lithium battery is charged via a USB port.

4. The system as claimed in claim 1, wherein frequency band of both the first ISM module and the second ISM module is 2.4 GHz band.

5. The system as claimed in claim 1, wherein both the first microphone set and the second microphone set include a phone microphone, a monitor microphone, and a walkie talkie wireless microphone respectively.

6. The system as claimed in claim 5, wherein the phone microphone, the monitor microphone, and the walkie talkie wireless microphone are selected from the group consisting of a dynamic microphone, a condenser microphone, an electret condenser microphone and a MEMS microphone.

7. The system as claimed in claim 1, wherein the terminal device is selected from the group consisting of a smartphone, a tablet computer, a laptop computer, a desktop computer and an audio player.

8. The system as claimed in claim 1, wherein both the primary headphone and the secondary headphone are arranged with a volume button for adjusting volume respectively.

9. The system as claimed in claim 1, wherein the primary headphone is either a circumaural headphone or an ear-fitting headphone; the secondary headphone is either a circumaural headphone or an ear-fitting headphone.
